(19) United States
(12) Patent Application Publication
(10) Pub. No.: US 2017/0061488 A1
(43) Pub. Date: Mar. 2, 2017

(54) Location Data System

(71) Applicant: Jesse Raymond Ilminen, Minneapolis, MN (US)

(72) Inventor: Jesse Raymond Ilminen, Minneapolis, MN (US)

(21) Appl. No.: 14/843,011

(22) Filed: Sep. 2, 2015

(51) Int. Cl. G06Q 30/02; H04W 4/02

(52) U.S. Cl. CPC G06Q 30/0261; H04W 4/028; H04W 4/023; G06Q 30/0267

(57) ABSTRACT

The technology disclosed herein relates to a system and method for acquiring and disseminating location-based data. In one embodiment, the system periodically collects location data from each of a plurality of mobile devices by a server. The location data identifies the presence of each mobile device at a particular business location and a particular time at which the mobile device is at the particular business location. The collected location data is maintained in a database. The system identifies a movement pattern of the plurality of mobile devices from the collected location data, which identifies the presence of one or more mobile devices at a first business location after presence of the one or more mobile devices at a second business location. The identified movement pattern is reported to users.

This disclosure is directed to a method of utilizing the Global Positioning System (or other locational awareness technologies) in conjunction with internet-enabled mobile devices as part of a software program (and/or internet-based service) to allow people to determine places to go to (such as a popular bar or nightclub) or places to avoid (such as a busy DMV office or a restaurant with long wait times) by checking on a set of parameters and factors, such as how many other people are at a given location and how long they remain there, on average, or other parameters that users will be able to search by. This process and the software and hardware that make it possible will collectively be referred to here as the Locational Data System (LDS).

By using this software application or internet service, people can, for example, decide which bars are busiest on a Friday night, and seek out crowds or people when they wish to be at a popular venue. Alternately, when seeking to avoid crowds or save time, they can use the LDS to determine, for instance, which Department of Motor Vehicles office has the shortest wait times, as estimated by how long other users have been remaining at that location in the last few hours, or which parks are the quietest, as estimated by how few users are at a given park at the moment.

The process works via the following method:

Users of the system will have a software program (a smartphone app or similar technology) that makes up the mobile part of the system installed on their mobile devices. (Such mobile devices could include smartphones, tablets, internet-enabled vehicles, laptops, smart watches, etc.) This program periodically checks their current location, via GPS, WiFi, or other locational awareness technology. Via the internet, WiFi, or other form of data transmission, it then reports which user is at that location to computer servers that run the central portion of the system. These central servers keep track of where users are and how long they have been there. It records the data received to a database of which users are at what locations, what businesses are at various locations, how long users stay at those places, and potentially a variety of other data. From this data, it can tell how many users are at a given location, and how long they are staying there on average. It can also keep track of past trends about which locations tend to be busy at what times and days.

Other users can then use the software application on their own mobile devices or computers to search for specific types of businesses within certain parameters, such as for nightclubs with at least 50 people in them, or for DMV offices that people stay at for an average of less than one hour. The server then finds places matching these criteria and displays a list of results and/or a real-time map showing where the locations that meet the search criteria are in relation to the user's location, and relevant information such as the average time other users have been staying at that location (to calculate wait times for service, for instance), estimated total number of people at that location, or actual number of fellow users at that location. Using the user's location, the locations of the various sites that fit the user's needs, and available navigational applications, the server could also provide users with a recommended location to go to, taking into account estimated driving or walking time to get to each site as well as estimated wait times for service.

Depending on the privacy wishes of users and agreements with the person or company operating the service, more information could be disclosed, enabling more advanced search parameters. For instance, users could fill out a user profile that would be submitted to the computer servers that run the service. This would enable people to search for more specific locations based on parameters involving other users more specifically.

As an example, a female 24 year old user could perform a search for bars within a 15 minute walking distance that have at least 10 single males between the ages of 22 and 29. This or other information users provide could enable the Locational Data System to serve as a useful tool for dating, coordinating meetings with friends, finding new places popular with other users with similar traits or tastes, or a variety of other services.

Some examples of other user-related information that could be gathered and reported include ratio of men to women at a location, average age of users at a location, number of friends at a location, location and distance to nearest restaurant with friends in it, and many more.

In addition to expanded information about users, expanded information about locations and businesses could also be added to give users more search options. This information might be self-reported by businesses, available from public records, or added via other means such as user reviews or reports. A user could search for bars within 5 miles that have not had any calls for police or medical assistance within the last six months, thus increasing user safety.

Another possible use is providing data and analysis to users, business managers, and others to find trends in past locational data that can assist in planning for future events or reveal other insights. For example, analysis of movement patterns of users over the last several months could reveal that people that go to John's Restaurant on Fridays at 6 p.m. tend to go to bars afterwards. The business owner could use this information to decide to increase the number of drinks available at his restaurant, potentially keeping customers drinking there instead of leaving for a bar, thus increasing sales.

For another example, assume a music venue named The Rock Palace had been very popular, but was now losing customers. The business owner could request data from the LDS to see where the customers were going instead. Learning that most of his lost customers were going to a venue with a dance floor that had played a lot of swing music, he could add a dance floor and change the music at his business to try to win them back.

The software that people use to interact with the Locational Data System could also be used to advertise to them, based on where they are, such as sending a coupon for free appetizers at Restaurant A to people who have just pulled in to the parking lot of Restaurant B, to try to win them over.

This system can also be used to find out the estimated waiting in line time at a local airport on a given day, based on real-time data, to assist in travel plans. It could help people find gyms that aren't busy when they get done with work and want to work out. Or the same for supermarkets, clinics, galleries/museums, or offices or stores of various kinds.

All of the data collected and disseminated by the LDS would be controlled to apply with all applicable laws and privacy agreements between users, businesses, and operators of the system, and to ensure users' safety at all times.

1. A method comprising:
periodically collecting location data from each of a plurality of mobile devices by a server, wherein the location data comprises at least identification of the presence of each mobile device at a particular business location and a particular time at which the mobile device is at the particular business location;
maintaining the collected location data in a database;
identifying a movement pattern of the plurality of mobile devices from the collected location data comprising identifying the presence of one or more mobile devices at a first business location after presence of the one or more mobile devices at a second business location; and
reporting the identified movement pattern to users.

2. The method of claim 1, further comprising classifying each particular business location by type of business.

3. The method of claim 1, further comprising sending an advertisement to a mobile device from the plurality of mobile devices in response to collecting location data, wherein the advertisement is on behalf of a competitor to the particular business location.

4. The method of claim 1, wherein identifying the movement pattern of the plurality of mobile devices further comprises characterizing the type of business at the first business location and the second business location.

5. The method of claim 1, further comprising analyzing the location data to report past trends in busyness based on day and time.

6. The method of claim 1, further comprising estimating a length of time each mobile device of the plurality of mobile devices was present at the particular business location based on the collected location data.

7. The method of claim 6, further comprising calculating an estimated wait time for service based on the collected location data and providing the estimated wait time to a user.

8. The method of claim 1, wherein the location data further comprises user profile information associated with each mobile device.

9. The method of claim 8, further comprising analyzing user profile information to report data for a searched business location, wherein the data comprises demographic information.

10. The method of claim 1, further comprising reporting, in response to a search by a user, a business location that has the shortest wait time.

11. A system comprising
a server configured to periodically collect location data from each of a plurality of mobile devices, wherein the location data comprises identification of the presence of each mobile device at a business location at a particular time;
a database in communication with the server, wherein the database is configured to maintain the periodically collected location data,
wherein the system is configured to identify movement patterns of the plurality of mobile devices from the collected location data comprising identifying the presence of one or more mobile devices at a first business location after presence of the one or more mobile devices at a second business location and report the identified movement patterns to a user.

12. The system of claim 11, wherein the system is configured to classify each particular business location by type of business.

13. The system of claim 11, wherein the system is configured to send an advertisement to a mobile device from the plurality of mobile devices in response to collecting location data, wherein the advertisement is on behalf of a competitor to the particular business location.

14. The system of claim 11, wherein the system is configured to characterize the type of business at the first business location and the second business location to identify the movement pattern of the plurality of mobile devices.

15. The system of claim 11, wherein the system is configured to analyze the location data to report past trends in busyness based on day and time.

16. The system of claim 11, further configured to estimate a length of time each mobile device of the plurality of mobile devices was present at the particular business location based on the collected location data.

17. The system of claim 16, further configured to calculate an estimated wait time for service based on the collected location data and provide the estimated wait time to a user.

18. The system of claim 11, wherein the location data further comprises user profile information associated with each mobile device.

19. The system of claim 18, further configured to analyze user profile information to report data for a searched business location, wherein the comprises demographic information.

20. The system of claim 11, further configured to report, in response to a search by a user, a business location that has the shortest wait time.
